(19) United States
(12) Patent Application Publication
(10) Pub. No.: US 2009/0238651 A1
(43) Pub. Date: Sep. 24, 2009

(54) Adjustable center high tool holder head

(76) Inventor: Bill Nguyen, Carson, CA (US)

Correspondence Address: BILL NGUYEN, 16536 SAN PEDRO ST., CARSON, CA, 90746, US

(21) Appl. No.: 12/077,925

(22) Filed: Mar. 24, 2008

(51) Int. Cl. B26D 7/26

(52) U.S. Cl. 407/104

(57) ABSTRACT

An adjustable center high head tool holder for holding a cutting insert includes a flexible head, square or rectangle shank; a special button head screw for two ways forces against the bottom seat support surface and the angular side walls of an insert receiving pocket; the adjustable head having a slot for flexibility, a socket set screw to push up the tool holder head and other socket head screw to clamp down the tool holder head for adjusting the right center high of the tool holder head.

### BACKGROUND OF THE INVENTION

This present invention relates to the tool holder for cutting insert for CNC lathe machine and more practical for adjustment of the center high of the tool holder head. The precise center high of cutting insert of the tool holder axis is known to be necessary in order to increase cutting inserts life and leave no tip in the center of the facing parts. Its unique designed allows easy adjustment of the center high axis of a tool holder by flexible head.

### SUMMARY OF THE INVENTION

The present invention relates to the tool holder for holding cutting insert. The tool holder is to provide an easy adjustment of center high of cutting insert, comprises: an adjustable head having a slot cut through one wall of the hole for flexible head, two Screws passing through two internally threaded holes in the head, a set screw pushing up the tool holder head for adjusting the higher center line and a socket head cap screw for clamping down the tool holder head for adjusting the lower center line; and tightening the tool holder head. The cutting insert is held in place by a socket button head cap screw clamp, which applies two ways forces against the bottom insert support surface and the angular side walls of an insert receiving pocket.

### BRIEF DESCRIPTION OF THE DRAWINGS

FIG. 1 is an exploded side perspective view of tool holder according to the present invention.

FIG. 2 is multiple sectional views of the tool holder and the socket button head cap screw shows un-clamp position.

FIG. 3 is a view similar to FIG. 2, but showing the socket button head cap screw in clamping position.

FIG. 4 is a view similar to FIG. 3, but showing adjustable head by hidden lines.

FIG. 5 is a front view of the tool holder

FIG. 6 is a view similar to FIG. 1 but has the insert-shim 8.

FIG. 7 is a view similar to FIG. 2 but has the insert-shim 8.

FIG. 8 is a view similar to FIG. 3 but has the insert-shim 8.

FIG. 9 is a view similar to FIG. 4 but has the insert-shim 8.

FIG. 10 is an enlarge cross-view of the clamp socket button head cap screw.

FIG. 11 and FIG. 12 are side view of the prior art

### DETAILED DESCRIPTION OF THE INVENTION

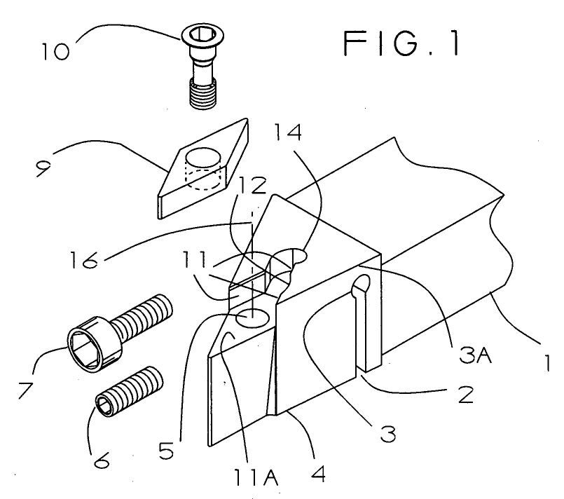

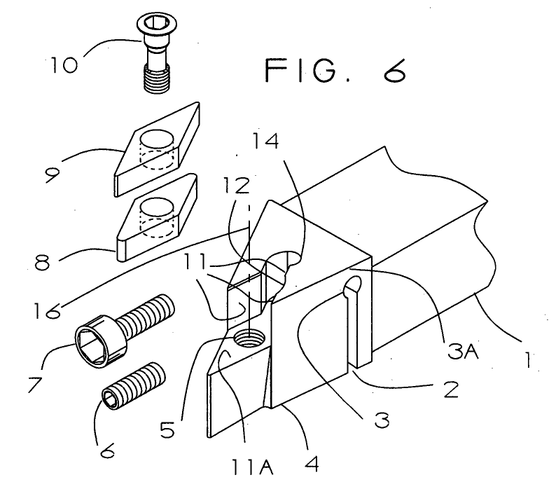

As showing FIG. 1 and FIG. 6 is similar but FIG. 6 having a insert shim 8, schematically illustrates the tool holder for used on CNC lathe or conventional lathe machines. The adjustable center high tool holder head comprises: a tool holder body square or rectangle shank 1, an adjustable head 4 including the insert receiving pocket comprise a bottom supporting seat 11A, and three side surfaces upstanding 11, include angular of 35 degree (VN style), or 55 degree (DN style), or 80 degree (CN style), or 60 degree (TN style) and 80 degree (WT style) from the bottom supporting seat 11A, a clearance recess arc 12 hole 5 having a center line 16 situated in the bottom support seat surface 11A, the clearance recess 14 for the radius nose of cutting insert, a slot 2 cut through one wall of the hole 3, created a thin wall at upper surface 3A for flexible head 4, a socket set screw 6, a socket head cap screw 7, and an insert

shim 8, a cutting insert 9, a clamp socket head cap screw 10

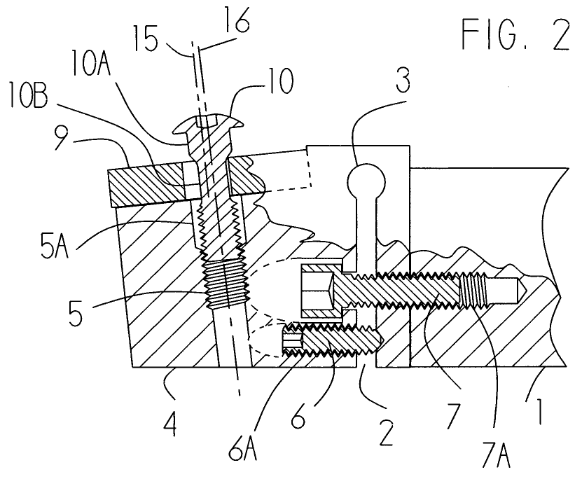

As showing in FIG. 2 the center of the counter bore 5A and the internally threaded hole 5 having a center line 16, the cutting insert hole 9 having a center line 15, the center lines 15 and 16 is off set as shown, the special clamp socket button head cap screw 10 just begin tightening, the screw shoulder 10A is touching upper hole of cutting insert 9 and the annular neck 10B is straight.

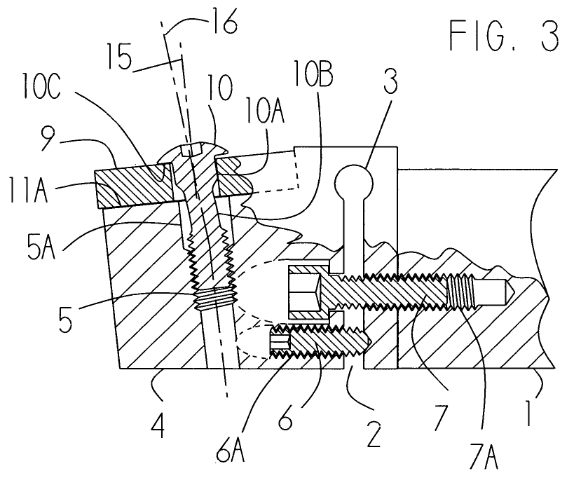

As showing in FIG. 3 the cutting insert 9 is held in place by a special socket button head cap screw 10, when the screw 10 is finally tightening down the screw flange 10C forces, clamps the cutting insert against the bottom surface of receiving pocket 11A while the annular neck 10B is bend create forces to the shoulder 10A against the angular side of three walls 11 (FIG. 1) causes by off set of center lines 15 and 16 illustrated in FIG. 3

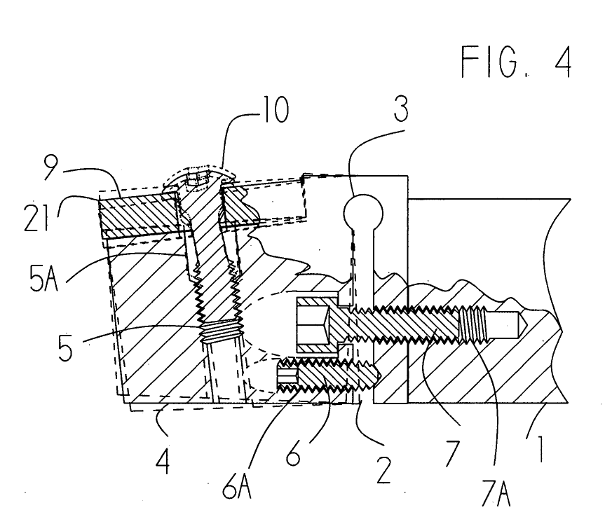

As showing in FIG. 4 to adjust the center high of cutting insert nose 21 and tighten the tool holder head 4, the two Screws 6 and 7 passing through two internally threaded holes 6A and 7A, a socket set screw 6 pushing up the adjustable head 4 and a socket head cap screw 7 for clamping the adjustable head 4 against the pushing up forces of the socket set screw 6.

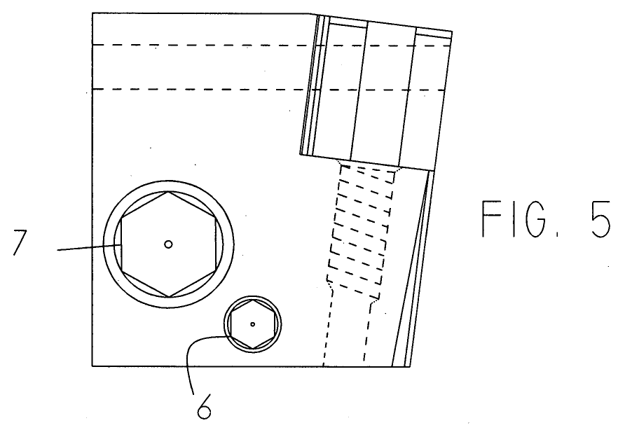

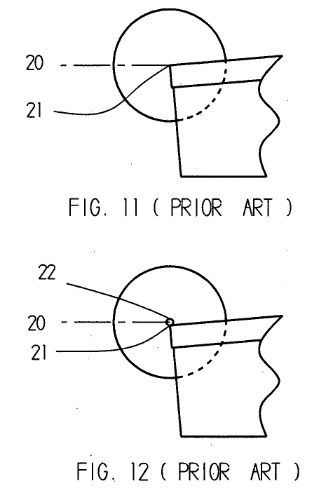

As showing in FIG. 5 is a front view of tool holder, a socket head cap screw 7, a socket set screw 6. As the prior art illustrated in FIG. 11 when the cutting insert nose 21 is matching the facing of a center line 20, leave no tip at the center. As the prior art illustrated in FIG. 12 when the cutting insert nose 21 is lower than facing of a center line 20 there will leave a tip 22 at the center.

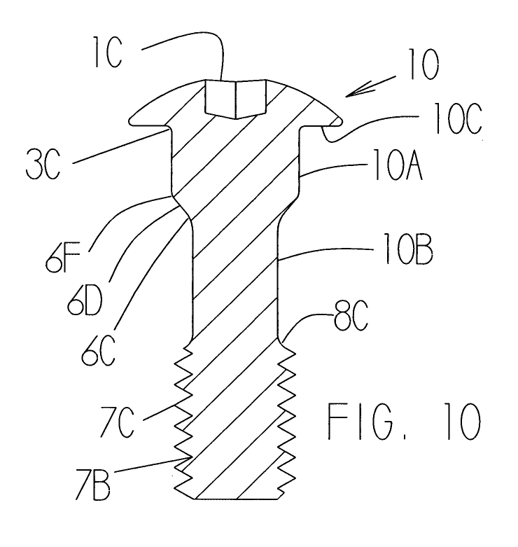

As showing in FIG. 10 a special socket button head cap screw 10 Included socket hex or torx 1C, a button head flange 10C, an annular shoulder 10A and the annular shoulder diameter is same as the major diameter of the threaded 7C, a annular flexible neck 10B and the annular neck diameter is same as the minor of the thread 7B, the fillet radius 8C and fillet radius 3C to prevent from crack. The fillet radius 6C the taper 6D and the fillet radius 6F is helping the screw bend easily when the screw tightening down.

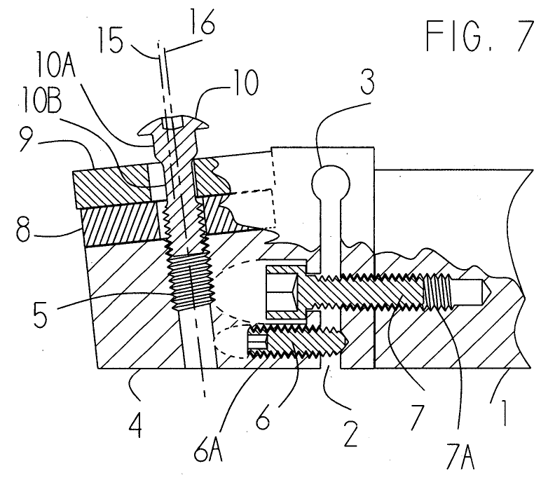

As showing in FIG. 7 is similar as FIG. 2 but FIG. 7 having a shim insert 8.

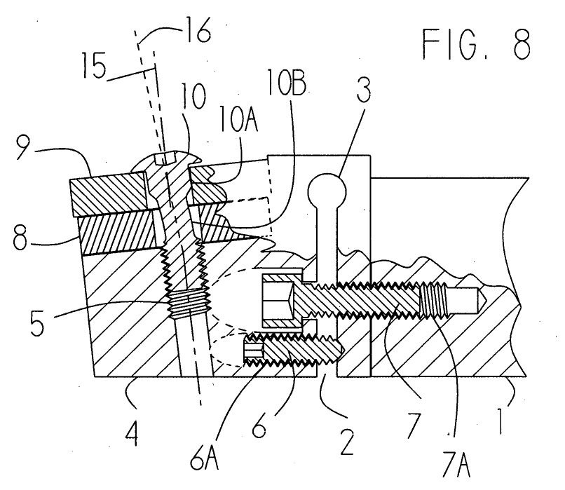

As showing in FIG. 8 is similar as FIG. 3 but FIG. 8 having a shim insert 8.

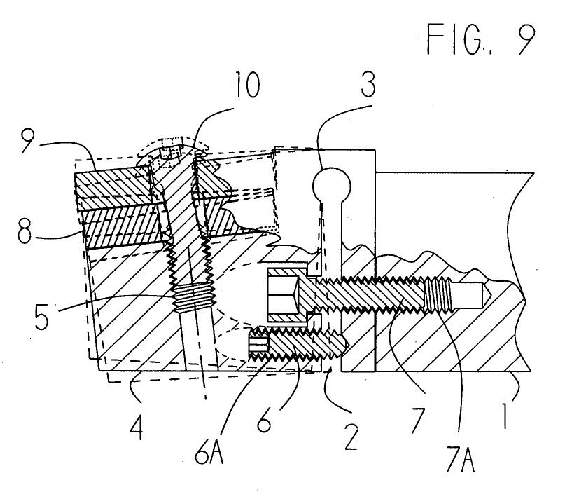

As showing in FIG. 9 is similar as FIG. 4 but FIG. 9 having a shim insert 8.

What is claimed is:

1. an adjustable center high tool holder for holding a cutting insert for CNC lathe or conventional lathe, comprising:
A flexible head having the insert receiving pocket, which includes a bottom supporting seat and three side-wall surfaces upstanding from the bottom supporting seat, form a 35 degree angle (VN-style), or 55 degree (DN style), or 60 degree (TN-style) or 80 degree (WN style), and a slot cut through one wall of the Hole, created a round thin wall below the top surface of the tool-holder-head for the flexibility of the head.

2. The tool holder, according to claim 1, further including a special clamp-socket-button-head-cap-screw for forcing down the insert against the bottom supporting-seat surface while forcing against three side walls.

3. The tool holder according to claim 2 wherein the special Clamp-socket button-head or round head-cap screw, having an annular shoulder, with the annular shoulder diameter is the same as the diameter of the major thread; an annular-grooved-flexible-neck with the diameter the same as the diameter of the minor thread; the width of the annular grooved neck is the same or one percent bigger than the thickness of the cutting insert.

4. the tool holder according to claim 1 wherein a clearance recess arc wall upstanding from the bottom seat support located between a side wall surface create three side supports walls for the insert receiving pocket;

5. The tool holder according to claim 1 wherein the internally threaded hole situated in the bottom seat support surface and the center of the hole is off set inwardly of side walls supports

6. The tool holder according to claim 5 wherein the counter-bore hole having internally threaded;

7. The tool holder according to claim 1 wherein the slot cut through one wall of the hole created a round thin wall below of the top surface of tool holder head created the flexible head;

8. The tool holder according to claim 1 wherein two parallel internally threaded holes having socket head cap screw and socket set screw passing through the slot for adjusting the tool holder head;

9. The tool holder according to claim 8 the tool holder head comprising: a socket set screw passing through the internally threaded hole in the tool holder head for adjusting and a socket head cap screw passing through the counter-bore hole having internally threaded in the head to tightening the head after adjusting the head.
